(19) United States
(12) Patent Application Publication
(10) Pub. No.: US 2005/0003244 A1
(43) Pub. Date: Jan. 6, 2005

(54) Direct hydrocarbon fuel cell system

(76) Inventor: Ai-Quoc Pham, San Jose, CA (US)

Correspondence Address: Ai-Quoc Pham, Suite 305, 780 Montague Expressway, San Jose, CA, 95131, US

(21) Appl. No.: 10/884,674

(22) Filed: Jul. 1, 2004

Related U.S. Application Data
(60) Provisional application No. 60/484,489, filed on Jul. 1, 2003.

(51) Int. Cl. H01M 8/24; H01M 8/06; H01M 8/04

(52) U.S. Cl. 429/12; 429/9; 429/19; 429/22; 429/23

(57) ABSTRACT

The present invention provides a direct hydrocarbon fuel cell system that comprises a direct hydrocarbon fuel cell and a higher temperature fuel cell connected in series. The system operates on direct hydrocarbon fuels without the need of a fuel reformer, and having improved electrochemical power output. Both fuel cells generate electricity. The fuel utilization level in the direct hydrocarbon fuel cell is controlled to avoid carbon deposition in the fuel cell that would degrade its performance. The exhaust from the direct hydrocarbon fuel cell, which contains steam, hydrogen-contained gas mixture and unreacted fuel, is fed directly into the high temperature fuel cell. The present invention thus relates to direct hydrocarbon fuel cell system for production of electricity having high efficiency and power output. The system can be a two stage fuel cell, or a system comprising two physically separated fuel cells, one direct hydrocarbon fuel cell and one regular fuel cell.

### CROSS-REFERENCE

This application claims benefit to U.S. Provisional Patent Application No. 60/484,489 filed Jul. 1, 2003 which are hereby incorporated by reference in their entirety.

### BACKGROUND OF THE INVENTION

1. Field of the Invention

The present invention relates to a direct hydrocarbon fuel cell system to generate electricity.

2. Background

Concerns about greenhouse gas effects have generated great interest in the development of energy technologies with low emissions. Fuel cells, which use electrochemical process rather than direct combustion and have much higher efficiency than conventional power generation technologies, have the potential to reduce greenhouse gas emissions by half or more. For this reason, fuel cells are being considered for stationary power generation as well as for transportation.

The fuel cell is a high effiency energy conversion electrochemical device that continuously changes the chemical energy of a fuel and oxygen directly to electrical energy and heat, without combustion. The basic structure of a single fuel cell includes an electrolyte layer sandwiched between a cathode (air side) and an anode (fuel side). The electrochemical reactions between the fuel and the oxygen supplied from air generate electricity, and a significant amount of heat that has to be disposed afterward.

Hydrogen is the preferred fuel for most fuel cells because of its high reactivity. To date, most fuel cells require a prior fuel processing step to convert hydrocarbon fuels to a more reactive mixture containing hydrogen and carbon monoxide (CO). This mixture can be used directly in high temperature fuel cells such as Solid Oxide Fuel Cells (SOFCs) and Molten Carbonate Fuel Cells (MCFCs). Low temperature Polymer Electrolyte Membrane Fuel Cells (PEMFCs), the leading candidate in transportation applications however requires a pure hydrogen fuel source, and thus the mixture containing CO and hydrogen must be further purified to remove CO.

The addition of an intermediate fuel processing step to convert hydrocarbon fuels to more reactive and efficient fuels for fuel cells causes a drop in the overall system efficiency. For instance, a typical fuel processor efficiency is about 80%, when used with a PEMFC having about 50% efficiency, the system efficiency drops to about 40%. Moreover, the fuel processor adds a significant cost and complexity to the fuel cell system. This cost can be even higher than the fuel cell stack cost and the fuel processor size can be even larger than the fuel cell stack itself, especially for PEMFCs.

Fuel cells that could operate directly on hydrocarbon fuels would eliminate the need for a fuel reformer, providing considerable economic advantages and presumably improving the viability of the technology. Many problems have been encountered when the fuel cells use the hydrocarbon fuel directly. For instance, the direct methanol polymer electrolyte fuel cells (PEMFCs) produce relatively low power density, requiring large quantities of precious metal loading of the anodes, and the methanol can permeate through the electrolyte. Furthermore, this approach seems to be limited to methanol fuel only.

Operation of MCFCs and SOFCs using direct hydrocarbon fuel is theoretically possible because the high temperature operations enable faster reaction kinetics. In practice however direct hydrocarbon fuels causes coking, or carbon deposition, on the anode that would degrade the performnance of the fuel cells. Accumulation of carbon solid in SOFC anode has been shown to cause serious problems, including cracking of the fuel cell anode.

The coking of hydrocarbon can occur via the following reactions:
CH₄C+2H₂ [2]
2CO C+CO₂ [3]
Reaction [2] is negligible at temperatures lower than 400° C. but becomes significant with increasing temperatures. Longer chain hydrocarbons also tend to have more coking at lower temperatures than shorter hydrocarbons. Some electrode and catalyst materials are also known to catalyze the coking of hydrocarbon. Nickel, which is the most widely used catalyst for steam reforming and for the fuel cell anode, is also a good catalyst for carbon deposition. Steam, in large quantities, can help preventing carbon deposition but its presence causes large fuel dilution and complex steam management.

There have been some successful development of direct hydrocarbon fuel cells and anode materials that are capable of resisting carbon deposition for direct hydrocarbon fuel cells. U.S. Pat. No. 6,214,485 disclosed a direct hydrocarbon fuel cell (DHFC) using anode containing ceria, where certain hydrocarbons such as methane and ethane can be injected directly to the SOFC anode chamber without the need for prior reforming. No carbon deposition was observed after 100 hours of operation. U.S. patent application Ser. No. 20010029231 disclosed a method to fabricate a direct hydrocarbon SOFC anode containing copper. Fuel cells fabricated using this method have been shown to be capable to operate directly on a number of hydrocarbon fuels including liquid fuels such as diesel, without any prior fuel conditioning. Pham et al., in U.S. patent application Ser. No. 2002127455 disclosed a ceria-based solid oxide fuel cell that provides high power output at low temperature.

Fundamentally, the DHFC differs from the conventional fuel cell in both the fabrication and the nature of the electrochemical reactions. The active chemicals for electrochemical oxidation in conventional fuel cells are hydrogen and to a lesser extent, CO, while in the DHFCs, the hydrocarbon is oxidized directly without being converted to intermediate species. The anode materials of the DHFC are more coke resistant and are better hydrocarbon oxidation catalysts than those of conventional fuel cell. Even so, there is risk of coking or carbon deposition at high temperatures. The DHFCs thus operate at reduced temperature to reduce or eliminate the carbon deposition. As a result, the power output from the DHFCs is typically lower than that of the conventional fuel cell. For instance, the fuel cells disclosed in U.S. Pat. No. 6,214,485 and in U.S. patent application Ser. No. 20010029231 are preferably operated at temperatures lower than 600° C. and 700° C. respectively. Lower operating temperature causes an increase in the fuel cell ohmic resistance as well as a lost in the electrode activity, which can result in significantly lower electrochemical performance. The power density of the direct hydrocarbon fuel cell disclosed in U.S. Pat. No. 6,214,485 is claimed to be 250 mW/cm² at 600° C., while the typical power density for conventional fuel cells requiring fuel processing is in the range of 0.5 to 1 W/cm². Therefore, the benefit of a direct hydrocarbon fuel cell is offset, if not annihilated by the lower power density that results in larger systems and thus higher materials and capital costs.

It would be a benefit for a fuel cell system capable of operating directly on hydrocarbon fuel without or with minimal fuel processing, while still having comparable power density to conventional fuel cells.

### SUMMARY OF THE INVENTION

The present invention provides a direct hydrocarbon fuel cell system that comprises a direct hydrocarbon fuel cell and a higher temperature fuel cell connected in series, thus providing an improved electrochemical power output. The direct hydrocarbon fuel cell operates directly from hydrocarbon fuels without the need of a fuel reformer, and the high temperature fuel cell produces electricity at high power density and efficiency. The fuel utilization level in the direct hydrocarbon fuel cell is controlled to avoid carbon deposition in the fuel cell that would degrade its performance. The exhaust from the direct hydrocarbon fuel cell, which contains steam, hydrogen-contained gas mixture and unreacted fuel, is fed directly into the high temperature fuel cell. The present invention thus relates to direct hydrocarbon fuel cell system for production of electricity having high efficiency and power output. The system can be a two stage fuel cell, or a system comprising two physically separated fuel cells, one direct hydrocarbon fuel cell and one regular fuel cell.

One advantage of the present invention is the improved efficiency of the system. The role of the direct hydrocarbon fuel cell is to reform the fuel for efficient production of electricity by the high temperature fuel cell. At the same time, electricity is also generated by the direct hydrocarbon fuel cell. External source of heat or steam required for the electrochemical reactions in the high temperature fuel cell is not needed since the steam is supplied in-situ by the direct hydrocarbon fuel cell. Furthermore, since the direct hydrocarbon fuel cell generates heat, this heat can serve to warm up the fuel gas without the need of additional heat input from external sources or from a heat exchanger. The direct hydrocarbon fuel cell system described in the present invention thus can be more efficient than fuel cells in prior art.

Another advantage of the present invention is the improved electrochemical output of the system. Most direct hydrocarbon fuel cells operate at low temperature to avoid carbon deposition in the fuel cell and as a result, they have lower power density than high temperature fuel cells. The present invention provide a two fuel cell system, in which most of the electrical production is generated in the high temperature fuel cell. Since the high temperature fuel cell can achieve much higher power density and output than the direct hydrocarbon fuel cell operating at reduced temperature, the system in the present invention generates electricity with higher power density and output than direct hydrocarbon fuel cells in prior art. Compared to the conventional high temperature fuel cell, the present system also can have higher power output because the fuel is not diluted with steam nor with nitrogen prior to being injected in the fuel cell.

The present invention also provides a system and method for networking different fuel cell types to enable any conventional high temperature fuel cells to be capable of operating directly on hydrocarbon without the need for extensive fuel processing. In this case, the direct hydrocarbon fuel cell serves as a fuel reformer for the high temperature fuel cell. The disclosure of fuel cell acting as a reformer has been submitted in a co-pending application of the same inventor, entitled “Co-Production of Hydrogen and Electricity Using A Fuel Cell Reformer”, hereby incorporated by reference. The direct hydrocarbon fuel cell operates directly from hydrocarbon fuels without the need of fuel reforming, and the high temperature fuel cell operates from the exhausted fuel from the direct hydrocarbon fuel cell which has been reformed in the electrochemical reactions in the direct hydrocarbon fuel cell.

### BRIEF DESCRIPTION OF THE DRAWINGS

FIG. 1 schematically illustrates the reactant process flow for a prior art conventional fuel cell operating on hydrocarbon.

FIG. 2 schematically illustrates the reactant process flow for a prior art direct hydrocarbon fuel cell.

FIG. 3 shows schematically the direct hydrocarbon fuel cell system that comprises a direct hydrocarbon fuel cell and a high temperature fuel cell.

FIG. 4 shows schematically the direct hydrocarbon fuel cell system that comprises a direct hydrocarbon fuel cell and a high temperature fuel cell with an optional pre-reformer unit.

### DETAILED DESCRIPTION OF THE INVENTION

The term “fuel cell” or “fuel cell unit” as used herein means a fuel cell stack or a plurality of fuel cell stacks operating in similar conditions and performing the same functions. It is well known that due to size limitations and other reasons, several identical fuel cell stacks can be connected together to form a fuel cell.

The term “direct hydrocarbon fuel cell” as used herein means a fuel cell capable of operating directly on hydrocarbon fuel without the need of a prior fuel processing step. Direct hydrocarbon fuel cells differ from conventional fuel cells in their ability to oxidize the hydrocarbon fuel directly at the fuel cell anodes, and the ability to do so without risks of having the carbon deposition problem.

Reference will now be made in details to some specific embodiments of the invention. Examples of these specific embodiments are illustrated in the accompanying drawings.

A conventional fuel cell usually requires a fuel reformer to convert hydrocarbon fuels into more active fuels for fuel cell reactions. The fuel reformer conditions the hydrocarbon fuels to more reactive fuel for the fuel cell. There are various methods for fuel reforming: steam reforming, a partial oxidation or autothermal reforming. Of these methods, the steam reforming is the most popular.

Steam reforming consists of reacting hydrocarbon fuels with steam to create carbon monoxide and hydrogen. For methane fuel, the reaction is:

| | | |
|---|---|---|
| CH₄ + H₂O → CO + 3H₂ | ΔH = 206 kJ/mol CH₄ | [1] |

This reaction is highly endothermic and requires burning up to 25% of the fuel to provide the necessary heat. It also requires large excess of steam, as much as two to three time more steam than carbon, in order to prevent carbon deposition. The use of large amounts of steam causes dilution of the fuel, which causes lower electrochemical performance in the fuel cell.

Partial oxidation involves the use of a sub-stoichiometric amount of air or oxygen to partially combust the fuel. The combustion provides the energy needed to drive the reaction. Since no indirect heat transfer is needed, the partial oxidation processor is more compact and better suited for small-scale fuel processing. The issue here is the large dilution of the fuel with nitrogen if air is used as oxidant. This large dilution can results in significant drop in fuel cell performance. For instance a reformate gas generated from a partial oxidation processor can contain 19% hydrogen, 24% CO, 1% CO2 and as much as 56% nitrogen on a dry gas basis. When considering the presence of steam, the dilution of useful fuel is even more severe. The partial oxidation processor described above showed a fuel cell performance of less than 60% of what is normally observed if pure hydrogen were used as the fuel.

Autothermal reforming is a combination of the steam reforming and partial oxidation reactions. Autothermal reforming faces the same issue with dilution due to nitrogen in air.

If low temperature fuel cells such as the Polymer Electrolyte Membrane Fuel Cells (PEMFCs) are used, the reformate gas coming from the above reformers must be further purified to remove CO from the gas stream. This involves a high and a low temperature water-shift reactors, followed by a methanantion or preferential oxidation units. The concentration of CO must be reduced to 10-20 ppm in order not to poison the electrode/catalysts of the fuel cells. The fuel processing for PEMFCs is thus complex and expensive. The fuel processor efficiency is at best between 70 to 80%. Assuming a typical efficiency of 50% for PEMFC, the system efficiency drops to below 40% when the fuel conversion step is included.

On the other hand, high temperature fuel cells such as Molten Carbonate Fuel Cells (MCFCs) and Solid Oxide Fuel Cells (SOFCs) are not susceptible to CO poisoning and the reformate gas can be used directly. Since these fuel cells operate at high temperatures, 650° C. for MCFCs and between 500 to 1000° C. for SOFCs, the heat they generate can also be efficiently used for reforming hydrocarbon fuels, thus resulting in a higher overall efficiency than that of the PEMFCs.

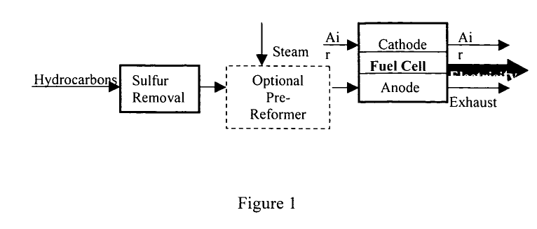

FIG. 1 shows schematically a prior art fuel cell system that includes a solid oxide fuel cell and a steam reformer. Hydrocarbon fuel is first subjected to desulfurization since sulfur can poison the reformer and fuel cell catalysts. Desulfurized hydrocarbon is then mixed with steam prior to entering the reformer. Large excess of steam, up to 2 to 3 times the amount of carbon in the hydrocarbon molecule, is required in order to prevent coking or carbon deposition on the reforming catalyst and/or on the fuel cell anode. The steam reforming is highly endothermic and thus requires a large heat input. For high temperature fuel cell, this heat can be readily supplied by the fuel cell.

The reformed fuel, containing hydrogen, CO, steam, CO₂ and some residual unconverted hydrocarbons then enters the fuel cell anode chamber. Oxygen containing gas is flown in the fuel cell cathode. When an electrical current flows through the fuel cell, oxygen is electrochemically reduced to oxygen ions, according to:
½O₂+2e⁻→O²⁻ [4]
e⁻ denotes an electron. The ions diffuse through the solid electrolyte membrane of the fuel cell, this electrolyte being an oxygen ion conductor. Arriving on the anode side of the fuel cell, the oxygen ions react electrochemically with hydrogen or CO₂ according to:
H₂+O²⁻→H₂O+2e⁻ [5]
CO+O²⁻→CO₂+2e⁻ [6]
The fuel utilization is well defined in the case of hydrogen fuel. It is the ratio between the number of moles of hydrogen reacted over the number of moles of hydrogen introduced in the fuel cell. In the case of hydrocarbon fuel, a similar definition can be used but it is difficult to correlate with actual experimental data since most of the hydrocarbons are readily converted by the fuel processor to CO and hydrogen. A better definition relies on the oxidation power of each molecule. In the case of methane fuel, the fuel utilization is defined as:
U_{f}(%)=[1−nH2+nCO+4nCH4)out/(nH2+nCO+4nCH4)in]×100 [7]
Where n denotes the respective molar flows of each reactant.

Fuel utilization is controlled to be as high as possible, 80% or higher to convert as much as possible the energy in fuel to electricity. The remaining fuel is combusted in an after-burner.

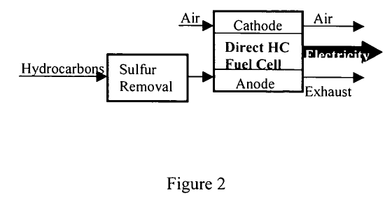

FIG. 2 shows a schematic illustration of prior art of a direct hydrocarbon solid oxide fuel cell. The direct hydrocarbon solid oxide fuel cell operate directly from hydrocarbon fuels, and the reformer is no longer needed. Hydrocarbon, after being desulfurized, is fed directly into the fuel cell anode chamber where it is electrochemically oxidized at the fuel cell anode. Using gas chromatography, it has been proved that the reaction is a total oxidation, according to:
CH₄+4O²⁻→CO₂+2H₂O+8e⁻ [8]
Once again, it is desirable to have fuel utilization in the DHFC as high as possible for the same reason as for the conventional high-temperature fuel cell described above.

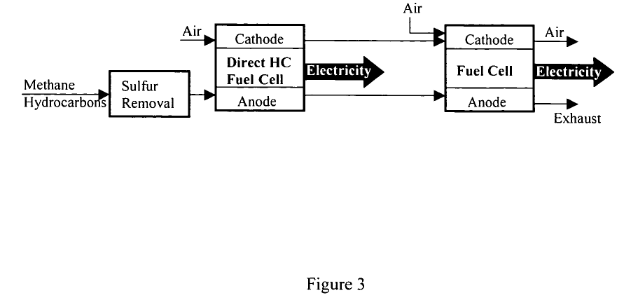

The present invention provides a direct hydrocarbon system that can operate directly on hydrocarbon fuels, but also capable of producing high power output and system efficiency comparable to those of conventional high temperature fuel cells. FIG. 3 schematically illustrates the direct hydrocarbon fuel cell system of the present invention, that comprises of a direct hydrocarbon fuel cell, and a regular fuel cell, connected in sequence. The direct hydrocarbon fuel cell, DHFC, operates at reduced-temperatures, preferably below 700° C., and more preferably below 600° C., and the regular fuel cell operates at high temperature for optimum oxidation. Hydrocarbon is first subjected to desulfurization as usual. Then the desulfurized hydrocarbon is injected directly in the anode chamber of the DHFC. Oxygen containing gas is flown in the DHFC cathode. When electrical current is passing through the DHFC, the hydrocarbon fuel is converted to a mixture of steam and CO₂ according to reaction [7].

As mentioned earlier, since the high temperature fuel cell is more efficient than the DHCF, the system efficiency is higher when more fuel is oxidized to generate electricity in the high temperature fuel cell. The fuel utilization in the DHFC is kept as low as possible, just enough to produce the minimum amount of steam and CO₂ needed to enable the prevention of carbon deposition in the high temperature fuel cell. The fuel utilization in the DHFC is controlled so that the (steam+CO₂) mixture to carbon ratio in the mixture leaving the DHFC is at least 2, more preferably 2.5 or higher. For methane fuel for instance, this means that the fuel utilization in the DHFC is controlled to be least 40% to have a (steam+CO₂) to carbon ratio of 2. The upper limit for the fuel utilization in the DHFC corresponds to a (steam+CO₂) over carbon ratio of 3, i.e. 50% utilization. The more fuel converted in the higher power fuel cell, the smaller is the system size and thus the lower is the cost.

The exhaust gas leaving the DHFC is thus composed of un-reacted methane, steam and CO₂, with a (steam+CO₂) over carbon ratio of at least 2. This exhaust is then directed to a high-temperature fuel cell in FIG. 3, which is located down stream in the process flow. The regular high temperature fuel cell operates at higher temperature than the DHFC, between 650° C. to 1100° C. The higher operating temperature enables higher power output and smaller stack size. The presence of large quantities of steam and CO₂ at high temperatures enables fuel reformation directly at the high temperature fuel cell anode, according to reactions [1] and [9]:
CH₄+CO₂→2CO+2H₂ [9]
Both reactions [1] and [9] convert hydrocarbon fuels to hydrogen and CO, similarly to the conventional fuel processor. Hydrogen and CO serve then as a fuel for the electrochemical oxidation in the high temperature fuel cell. The fuel utilization in the high temperature fuel cell is controlled to be as high as possible, preferably above 80%.

A system containing multiple fuel cells connected in series, such as that described in the present convention, can take advantage of the exhausted air from one another. The air exhaust from DHFC can be directed to the inlet of the cathode chamber of the high temperature fuel cell. This approach of series connecting two fuel cell stacks operating at two different temperatures has the advantage of enabling air flow to warm up in the reduced-temperature DHFC prior to entering the high temperature fuel cell, thus eliminating the need for extensive heat exchangers. Additionally, external air or oxygen can be mixed with the air coming from the DHFC prior to entering the high temperature fuel cell if a higher air flow rate is needed.

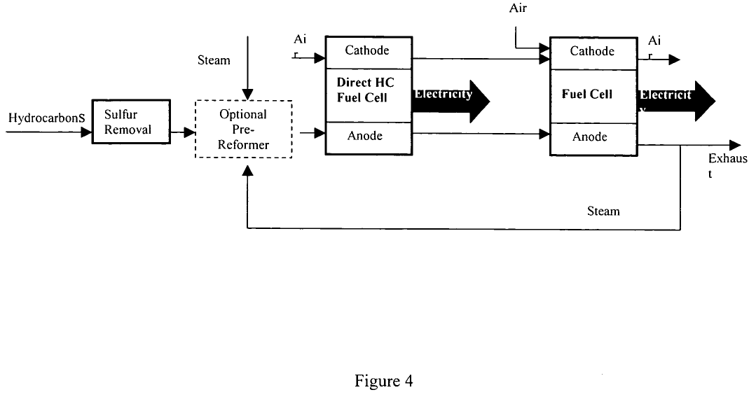

A pre-reformer unit can be utilized when a hydrocarbon fuel other than methane is used to reduce the risk of carbon deposition. The role of the pre-reformer is to break down long hydrocarbon chains to hydrogen and CO. Other hydrocarbon fuels, including methane in practice, contain a significant amount of long chain hydrocarbons that would cause carbon deposition in the DHFC. In the case of natural gas for instance, longer chain hydrocarbons that can make up to 10-15% in concentration, depending on the source of the gas. It is preferable to eliminate the long chain hydrocarbons. The pre-reformer typically operates at lower temperatures, below 600° C., which is compatible with the operating temperature of the DHFC. A small quantity of steam, enough to reform the long chain hydrocarbons contained in the fuel is provided, either by re-circulating some of the exhaust from the high temperature fuel cell or by boiling water. FIG. 4 shows the schematic of the direct hydrocarbon fuel cell system with the pre-reformer unit for other hydrocarbon fuels other than methane.

In another embodiment of the present invention, only one fuel cell stack, capable of operating with a large thermal gradient between the fuel inlet and outlet, is needed. The thermal gradient can be at least 100° C. The design of this embodiment thus combines the direct hydrocarbon fuel cell and the second fuel cell in the previous embodiment into one fuel cell. Close to the inlet, the fuel cell operates as a direct hydrocarbon fuel cell. As temperature raises due to the heat generated by the fuel cell, and as more steam is formed by the fuel oxidation, the steam reforming occurs.

Another embodiment of the present invention is a two-stage fuel cell that operates similar to the previous embodiment—direct hydrocarbon fuel cell reaction in one stage to generate electricity and steam that is fed to the second stage for the steam reforming reaction to generate hydrogen and electricity. The two-stage fuel cell can be either a system with two fuel cells that are physically separated, or a single fuel cell having two operating zones. The first one, fuel cell or zone, being a direct hydrocarbon fuel cell and the second one being a high temperature fuel cell. Both fuel cells generate electricity.

The two-stage fuel cell can have higher efficiency. It does not require a large quantity of water, and burning part of the fuel to provide the heat to boil water and to heat the steam to the operating temperature, and complex heat exchangers to recuperate the exhaust heat.

The present invention also provides a method for the production of electricity by a two-fuel cell system, that comprises of a direct hydrocarbon fuel cell, and a regular fuel cell, connected in sequence. The direct hydrocarbon fuel cell, DHFC, operates at reduced-temperatures, preferably below 700° C., and more preferably below 600° C., and the regular fuel cell operates at high temperature, for optimum oxidation. When the hydrocarbon fuel is injected directly in the anode chamber of the DHFC, the hydrocarbon fuel is converted to a mixture of steam and CO₂. The fuel utilization in the DHFC is kept as low as possible, just enough to produce the minimum amount of steam and CO₂ needed to enable the prevention of carbon deposition in the high temperature fuel cell. The fuel utilization in the DHFC is controlled so that the (steam+CO₂) mixture to carbon ratio in the mixture leaving the DHFC is at least 2, more preferably 2.5 or higher. The upper limit for the fuel utilization in the DHFC corresponds to a (steam+CO₂) over carbon ratio of 3, i.e. 50% utilization. The fuel utilization in the DHFC is controlled by the oxygen input and the current density of the fuel cell. The exhaust gas leaving the DHFC is thus composed of un-reacted methane, steam and CO₂. This exhaust is then directed to the high-temperature fuel cell that operates at higher temperature than the DHFC, between 650° C. to 1100° C., and preferably higher than 700° C. The higher operating temperature enables higher power output and smaller stack size. Both fuel cells generate electricity.

While particular embodiments, materials, parameters, etc. have been illustrated and/or described above, such are not intended to be limiting. Various modifications, and equivalent substitutes may be incorporated into the invention as described above without varying the spirit of the invention, as will also be apparent to those skilled in this technology. In other instances, well-known process operations were not described in details in order not to unnecessarily obscure the present invention. In particular, various engineering details, including heat exchangers, blowers, valves, boilers, after-burner, electrical connections, etc. were purposely left out of the discussion. Those skilled in the art should be able to incorporate these components to the new system described above. Furthermore, while particular terminology is used in the description above to describe certain aspects of the present invention, one skilled in the art would understand that other equivalent terms may be substituted therefore. For example, the term “air” is used herein, for convenience sake, to refer to any oxygen containing gas suitable for use in the fuel cells.

1. A direct hydrocarbon fuel cell system for the production of electricity directly from hydrocarbon fuel, the direct hydrocarbon fuel cell system comprising
a first fuel cell operating on direct oxidation of hydrocarbon fuel; and
a second fuel cell coupled with the first fuel cell for using the steam generated by the first fuel cell,
wherein the fuel utilization of the first fuel cell is substantially below its optimum value.

2. A system as in claim 1 wherein the second fuel cell is a high temperature fuel cell.

3. A system as in claim 1 wherein the oxygen-containing outlet of the first fuel cell is connected to the oxygen-containing inlet of the second fuel cell.

4. A system as in claim 1 wherein the fuel utilization of the first fuel cell is between 40% and 80%.

5. A system as in claim 1 wherein the fuel utilization of the first fuel cell is less than 50%.

6. A system as in claim 1 wherein the fuel utilization of the second fuel cell is greater than 70%.

7. A system as in claim 1 wherein the fuel utilization of the second fuel cell is greater than 80%.

8. A system as in claim 1 wherein the fuel utilization of the first fuel cell is reduced so that the ratio of the (steam+CO₂) over carbon, is higher than 1.

9. A system as in claim 1 wherein the fuel utilization of the first fuel cell is reduced so that the ratio of the (steam+CO₂) over carbon, is higher than 2.

10. A system as in claim 1 wherein the first fuel cell operates at temperature lower than 700° C.

11. A system as in claim 1 wherein the first fuel cell operates at temperature lower than 600° C.

12. A system as in claim 1 wherein the second fuel cell operates at temperature higher than 650° C.

13. A system as in claim 1 wherein the second fuel cell operates at temperature higher than 700° C.

14. A system as in claim 1 wherein the second fuel cell operates at a high temperature than the first fuel cell.

15. A system as in claim 1 further comprising an additional oxygen-containing inlet to the second fuel cell.

16. A system as in claim 1 further comprising a pre-reformer to convert long chain hydrocarbons to CO and hydrogen for the first fuel cell.

17. A system as in claim 1 further comprising a recirculating system to recirculate part of the exhaust from the second fuel cell to provide steam and CO₂ for the pre-reformer.

18. A system as in claim 1 wherein the hydrocarbon fuel includes natural gas, propane, butane, liquefied petroleum gas, gasoline, diesel, methanol, or ethanol.

19. A system as in claim 1 wherein the first and second fuel cells belong to a single fuel cell unit or stack.

20. A system as in claim 1 wherein the fuel utilization of the first fuel cell is controlled by controlling the oxygen input to the first fuel cell.

21. A system as in claim 1 wherein the fuel utilization of the first fuel cell is controlled by controlling the current density of the first fuel cell.

22. A two-stage fuel cell system for the production of electricity directly from hydrocarbon fuel, the two-stage fuel cell system comprising
a first staged fuel cell operating on direct oxidation of hydrocarbon fuel; and
a second staged fuel cell coupled with the first staged fuel cell for using the steam generated by the first staged fuel cell,
wherein the fuel utilization of the first staged fuel cell is substantially below its optimum value.

23. A system as in claim 22 wherein the second staged fuel cell is a high temperature fuel cell.

24. A system as in claim 22 wherein the fuel utilization of the first staged fuel cell is between 40% and 80%.

25. A system as in claim 22 wherein the fuel utilization of the second staged fuel cell is greater than 70%.

26. A system as in claim 22 wherein the first staged fuel cell operates at temperature lower than 700° C.

27. A system as in claim 22 wherein the second staged fuel cell operates at temperature higher than 650° C.

28. A system as in claim 22 further comprising a pre-reformer for the hydrocarbon fuel for the first staged fuel cell to convert long chain hydrocarbons to CO and hydrogen.

29. A system as in claim 22 further comprising a recirculating system to recirculate part of the exhaust from the second staged fuel cell to provide steam and CO₂ for the pre-reformer.

30. A system as in claim 22 wherein the hydrocarbon fuel includes natural gas, propane, butane, liquefied petroleum gas, gasoline, diesel, methanol, or ethanol.

31. A system as in claim 22 wherein the fuel utilization of the first staged fuel cell is controlled by controlling the oxygen input to the first staged fuel cell.

32. A system as in claim 22 wherein the fuel utilization of the first staged fuel cell is controlled by controlling the current density of the first staged fuel cell.

33. A method for the production of electricity from hydrocarbon fuel by a two-fuel cell system, the method comprising the steps of:
controlling the fuel utilization of the first fuel cell to generate steam and CO₂ while allowing a substantial amount of hydrocarbon fuel to pass though unreacted;
reforming the unreacted hydrocarbon fuel in the second fuel cell utilizing the generated steam and CO₂.

34. A method as in claim 33 wherein the first fuel cell is a direct hydrocarbon fuel cell.

35. A method as in claim 33 wherein the first fuel cell also generates electricity.

36. A method as in claim 33 wherein the second fuel cell generates electricity by reforming reaction.

37. A method as in claim 33 wherein the second fuel cell is a high temperature fuel cell.

38. A method as in claim 33 wherein the operating temperature of the first fuel cell is lower than 600° C.

39. A method as in claim 33 wherein the operating temperature of the first fuel cell is lower than 700° C.

40. A method as in claim 33 wherein the operating temperature of the second fuel cell is higher than 650° C.

41. A method as in claim 33 wherein the operating temperature of the second fuel cell is higher than 700° C.

42. A method as in claim 33 wherein the first fuel cell is operated at a temperature lower than that of the second fuel cell.

43. A method as in claim 33 wherein the fuel utilization of the first fuel cell is between 40% and 80%.

44. A method as in claim 33 wherein the fuel utilization of the first fuel cell is less than 50%.

45. A method as in claim 33 wherein the fuel utilization of the second fuel cell is greater than 70%.

46. A method as in claim 33 wherein the fuel utilization of the second fuel cell is greater than 80%.

47. A method as in claim 33 wherein the control of the fuel utilization is accomplished by the controlling of the oxygen input to the fuel cell.

48. A method as in claim 33 wherein the control of the fuel utilization is accomplished by the controlling of the current density of the fuel cell.
